(19) United States
(12) Patent Application Publication
(10) Pub. No.: US 2011/0298573 A1
(43) Pub. Date: Dec. 8, 2011

(54) Electrical Machine With Improved Lightning Impulse Withstand

(76) Inventors: Arne Hjortsberg, Pfaffikon (CH); Jan Hajek, Ludvika (SE)

(21) Appl. No.: 13/156,176

(22) Filed: Jun. 8, 2011

Related U.S. Application Data
(63) Continuation of application No. PCT/EP2009/066588, filed on Dec. 8, 2009.

(30) Foreign Application Priority Data
Dec. 8, 2008 (EP) 08170944.6

(51) Int. Cl. H01F 27/32

(52) U.S. Cl. 336/196

(57) ABSTRACT

An electrical machine with an axis. The machine includes a winding arranged in a plurality of substantially circular turns wound around the axis. Wedge formed areas are formed between two adjacent turns of the winding. A member of insulating material is arranged to cover at least one of the wedge formed areas.

### CROSS-REFERENCE TO RELATED APPLICATIONS

The present application is a continuation of pending International patent application PCT/EP2009/066588 filed on Dec. 8, 2009 which designates the United States and claims priority from European patent application 08170944.6 filed on Dec. 8, 2008, the content of which is incorporated herein by reference.

### FIELD OF THE INVENTION

The present invention relates to electrical machines, and particularly to an electrical machine with improved electrical withstand to transients.

### BACKGROUND OF THE INVENTION

In electrical machines, due to the configuration of the winding, strong electrical fields occur locally with impulse voltages. In such areas there is an increased risk for an electrical breakdown in the cooling medium, such as transformer oil, being in contact with the winding.

A critical area is the wedge formed area between two adjacent turns of a winding in a winding in a power transformer, an area often exposed to locally strong electrical fields. Due to the difference of permittivity between oil and paper insulation, conventionally used in power transformers as cooling medium and insulation, respectively, there is an increased risk of electrical breakdown of the oil in such areas.

When the winding is submitted to impulse voltages e.g. by lightning surges or testing, the electric field stress in such a wedge is high which can initiate a partial breakdown of the oil, which might enable a streamer (spark) to propagate via the oil to a surface, i.e. a barrier, and to continue propagating to ground. If such streamers occur, they will cause serious damages to the transformer. To prevent the occurrence of streamers, an electrical machine like a power transformer needs to be dimensioned to cope with high electrical stress occurring locally in such areas as described above. As a result, power transformers are dimensioned to withstand electrical field strength being several times stronger than normal workload, thus resulting in costly, large and bulky machines.

U.S. Pat. No. 5,969,456 deals with a similar problem of electrical discharges, namely the problem of impulse voltage being unequally shared by winding portions in induction machines, tending to result in dielectric breakdown in a winding portion sharing excessively high voltage. To overcome this problem, an electromagnetic equipment having improved corona resistance and dielectric strength is described. In the known equipment, an electromagnetic winding is formed by winding an insulated wire comprising a cable having a conductor covered by an inner layer of insulating coating, and an outer low-resistance conductive layer of coating, the outer coating having a lower resistivity than the inner coating. By such arrangement, electric charges discharged by corona discharge can be restrained by the outer coating formed on the conductor. The conductive coating of each unit winding thus improves the corona resistance of each winding unit to ground. Further, the outer coating increases a series capacitance between winding conductors. Consequently, the voltage is equally shared by the windings of the electromagnetic winding, and the occurrence of strong electrical fields locally is reduced. As a result, improved insulation strength of the electromagnetic equipment relative to impulse voltages is achieved.

Although providing a winding with improved electrical withstand, a disadvantage with the known equipment is that such a winding provided with several layers of insulating material will be bulky and difficult to handle during winding of the machine. As a result, a machine provided with such a winding will be large and voluminous. Further, when the winding is wound in turns, there will still be a higher electrical field in the wedge between two adjacent layers, as described above.

It is a common failure mode for a spacer less winding subjected to fast transients, such as a voltage surge coming from lightning, is a flashover starting from the winding, bridging the first part duct and continuing towards ground, typically by following a surface of the winding or through the dielectric liquid to earth.

The prerequisites for such a failure are that there is an initiation of the breakdown followed by propagation and finally a change in streamer mode to a fast event.

The electrical breakdown of the dielectric liquid in an electrical machine is the final stage in an electrical breakdown process where the process starts with the formation of electrical streamers. Breakdown is characterized by the formation of an arc; an electrical short circuit through the liquid. Electrical streamers are highly conductive structures that form in dielectric liquids prior to the formation of an arc which allows large destructive currents to flow between two terminals, which would otherwise be insulated by the liquid.

If an electrical streamer bridges the gap between e.g. a winding and earth it will form a conductive short that could allow an arc to be formed.

### SUMMARY OF THE INVENTION

An object of the present invention is to provide an electrical machine overcoming the problem mentioned above with propagation of streamers in local areas exposed to strong electrical fields.

This object, among others, is according to the present invention attained by an electrical machine, as defined by the appended claims.

The idea in this invention is to stop the generation of a streamer and flashover already at the initiation. The probable location for the ignition of a streamer is in the wedge between the conductors in the winding. In this wedge there is a local very high stress in the oil due to the difference in permittivity between oil and paper used to isolate conductors. The electrical stress in the wedge can reach 100 kV/mm or more.

According to the present invention, an electrical machine with improved lightning impulse withstand is provided. The machine comprises a axis, and a winding arranged in a plurality of substantially circular turns wound around the axis. Wedge formed areas are formed between two adjacent turns of the winding. At least one member of insulating material is arranged to cover at least one of the wedge formed areas.

According to one embodiment of the invention, the winding comprises at least two consecutive turns being arranged essentially in a first plane, followed by at least two consecutive turns being arranged essentially in a second plane. The first and second planes are perpendicular to the axis. The at least one wedge formed area is formed in the periphery of the winding between the two planes.

According to another embodiment of the invention, the at least one wedge formed area is located in the outer periphery of the winding.

According to yet another embodiment of the invention, the at least one wedge formed area is located in the inner periphery of the winding.

According to another embodiment of the invention, the winding is wound essentially in more than two consecutive planes each being perpendicular to said axis, and wherein said at least one member of insulating material is arranged to cover at least one wedge formed area being formed between two consecutive planes, for which planes the turns shift from one plane to the other plane in the inner periphery of the winding.

According to another embodiment of the invention, the winding is wound essentially in more than two consecutive planes each being perpendicular to the axis, and wherein the at least one member of insulating material is arranged to cover said at least one wedge formed area being formed between two consecutive planes, for which planes the turns shift from one plane to the other plane in the outer periphery of the winding.

According to another embodiment of the invention, the member of insulating material is arranged in contact with the adjacent turns.

According to another embodiment of the invention, the member of insulating material is arranged to cover a plurality of the wedge formed areas.

According to another embodiment of the invention, the member of insulating material is an insulating paper.

According to another embodiment of the invention, the member of insulating material is a thin barrier.

According to another embodiment of the invention, the electrical machine is a power transformer.

According to another embodiment of the invention, the power transformer is chilled by a liquid, and the at least one wedge formed area is in contact with the liquid.

According to another embodiment of the invention the liquid is oil.

According to another embodiment of the invention, the liquid is ester fluid.

According to yet another embodiment of the invention, the power transformer is a 3-phase power transformer.

Further features and advantages of the present invention will be evident from the following detailed description.

### BRIEF DESCRIPTION OF THE DRAWINGS

The present invention will become more fully understood from the detailed description of embodiments given below and the accompanying figures, which are given by way of illustration only, and thus, are not limitative of the present invention, wherein:

FIG. 1a is a detailed drawing showing streamers occurring between two turns in a winding in a conventional electrical machine.

FIG. 1b is a detailed drawing showing two turns in a winding in an electrical machine according to the present invention.

FIG. 2 is a cross-sectional view of an electrical machine according to the present invention.

FIG. 3 is a top view of an electrical machine according to the present invention.

FIG. 4a is a detailed drawing showing two turns in a winding in an electrical machine with an isolating member according to one embodiment of the present invention.

FIG. 4b is a detailed drawing showing two turns in a winding in an electrical machine with an isolating member according to another embodiment of according to the present invention.

### DETAILED DESCRIPTION OF THE INVENTION

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

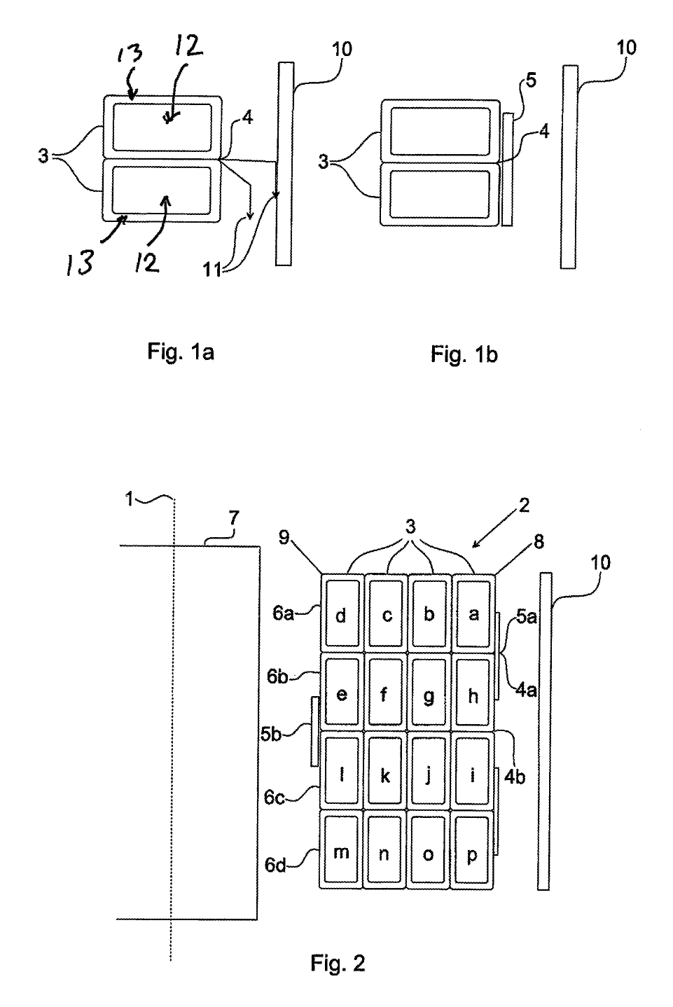

An embodiment of an electrical machine according to the present invention will now be described with reference to FIGS. 1-4.

FIG. 1a is a detailed drawing showing streamers generated in the wedge formed area and propagating from the wedge formed area between two turns 3 in a winding in an electrical machine, such as a power transformer, and towards earth. The electrical machine comprises a winding 2 with one, or a plurality of, insulated conductors wound in a plurality of turns 3 around an axis 1. The conductors 12 are surrounded by insulation 13 which is normally paper but other isolation materials can also be used. Between two adjacent turns 3 in the outer periphery of the winding 2, wedge formed areas 4 between the insulation 12 of the different conductors 11 are formed. Due to the configuration of the winding 2, strong electrical field will occur locally in the wedge formed area 4. The difference of permittivity between oil and paper insulation, often used in power transformers as cooling medium and insulation, respectively, increases the risk of electrical breakdown of the oil in such areas whereby an initiated streamer may be enabled to propagate through the oil to ground. In the figure, a streamer 11 propagating through the oil via a barrier 10 to ground is shown. Alternatively, a streamer 11 might be able to propagate directly to ground through the oil.

FIG. 1b is a detailed drawing showing the corresponding two turns 3 in a winding 2 in an electrical machine according to the present invention. The electrical machine comprises a winding 2 with one, or a plurality of, insulated conductors wound in a plurality of turns 3 around a axis 1. The winding 2 can be wound around a core or simply around the axis 1, so called air-cored winding such as the one used in an oil filled reactor. Between two adjacent turns 3 in the outer periphery 8 of the winding 2, wedge formed areas 4 are formed. Strong electrical field will occur locally in the wedge formed area, increasing the risk of propagating streamers. A member of insulating material 5 is arranged to cover the wedge formed areas. Charges occurring in the wedge formed area 4 are thereby trapped in the wedge and are not able to develop into propagating streamers. By such an arrangement, improved lightning impulse withstand is provided. An electrical machine, such as a power transformer or reactor, thereby better withstand electrical stress due to strong electrical fields and the risk of propagating streamers casing severe damages are limited.

FIG. 2 shows a cross-sectional view of details in an electrical machine according to one embodiment of the present invention. The machine comprises a core 7 with a axis 1, and a winding 2 arranged in a plurality of substantially circular turns 3 wound around the core 7 to form an electromagnetic winding. The winding 2 comprises four consecutive turns 3a, 3b, 3c, 3d arranged in a first plane 6a, followed by four consecutive turns 3e, 3f, 3g, 3h arranged in a second plane 6b, further followed by four consecutive turns 3i, 3j, 3k, 3l arranged in a third plane 6c and further followed by four consecutive turns 3m, 3n, 3o, 3p arranged in a fourth plane 6d.

The planes 6a, 6b, 6c and 6d are perpendicular in relation to the axis 1 of the core 7. The machine further comprises a barrier 10 around the core 7 and the winding 2. The axis 1 is shown in the figure to be vertical but it can also be horizontal or have any other direction.

As seen in the figure, in the outer periphery 8 of the winding 2, there are seven intermediate turns (turns 3a-3g) between planes 6a and 6b, while there is only one turn in the outer periphery between planes 6b and 6c (turns 3h and 3i). Therefore, the electrical field in the wedge formed area 4a will be much stronger than the electrical field in the wedge formed area 4b, thereby increasing the risk of propagating streamers in the wedge 4a with damages as a result. A member of insulating material 5a is arranged to cover the wedge formed area 4a, whereby charges are trapped in the wedge and prevented from developing propagating streamers. By trapping the charges inside the wedge they will therefore need more energy to escape and propagate. This means a higher withstand strength towards a breakdown and it will be possible to permit a higher stress in both the wedge but also in the duct.

Further, in the inner periphery 9 of the winding 2, there are seven intermediate turns (turns 3e-3h) between planes 6b and 6c. Therefore, the electrical field in the wedge formed area in the inner periphery 9 between plane 6b and plane 6c will be strong and a member of insulating material 5b is arranged to cover the wedge formed area.

The most important wedges to cover are the wedges formed by the winding turns connected to the entrance or exit conductor of the electrical machine, where the local electrical stress is the highest during a lighting pulse or when testing the electrical machine.

The member of insulating material 5a can also be arranged to cover all the outer wedge formed areas between windings a-h, h-i, i-p. The inner member of insulating material 5b can also be arranged to cover all the inner wedge formed areas between windings d-e, e-l, l-m.

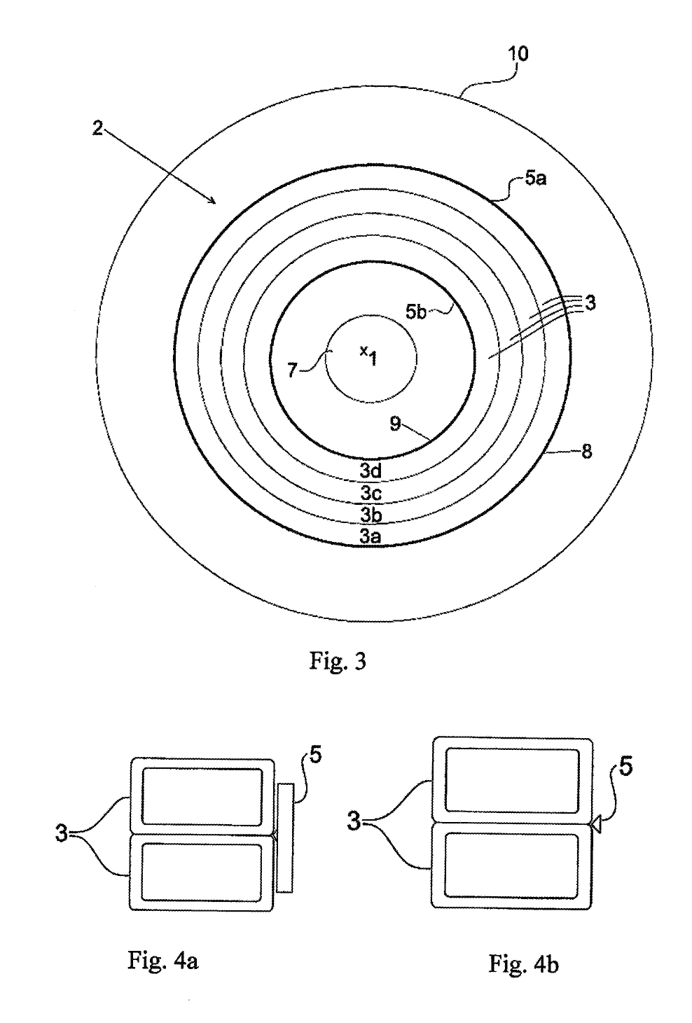

FIG. 3 shows details seen from above of an electrical machine according to one embodiment of the present invention. The machine comprises a core 7 with a axis 1, and a winding 2 arranged in a plurality of substantially circular turns 3 wound around the core 7 to form an electromagnetic winding.

The winding 2 comprises four consecutive turns 3a, 3b, 3c, 3d arranged in a first plane 6a, followed by four consecutive turns 3e, 3f, 3g, 3h arranged in a second plane 6b (not shown). The first and second planes 6a, 6b are perpendicular in relation to the axis 1 of the core 7. The machine further comprises a barrier 10 around the core 7 and the winding 2. A first member of insulating material 5a is arranged to cover the wedge formed area 4 (not shown) in the outer periphery 8 between the first and the second plane. Further, a second member of insulated material 5b is arranged to cover the wedge formed area 4 (not shown) in the inner periphery 9 between the first and the second plane. Thereby, the risk of propagating streamers occurring in the machine is reduced in an efficient way.

The insulating material (5) can be one or more layers of isolation paper normally used in oil-filled electrical machines or other types of cellulose based materials, such as presspan or pressboard. The insulating material can also be a polymer, for example, Nomex, a meta-aramid material.

FIGS. 4a and 4b shows examples of different forms of the isolating member 5. The member of insulating material 5 can have any practical form that prevents the propagation of streamers. In FIG. 4a the isolating member 5 is arranged with a wedge that fits into the wedge formed area 4 between two adjacent turns 3. In FIG. 4b the isolating member 5 is only a wedge that will fill the wedge formed area 4 between two adjacent turns 3.

It will be obvious that the present invention may be varied in a plurality of ways. Such variations are not to be regarded as departure from the scope of the present invention as defined by the appended claims. All such variations as would be obvious for a person skilled in the art are intended to be included within the scope of the present invention as defined by the appended claims.

1. An electrical machine with an axis comprising;
a winding arranged in a plurality of substantially circular turns wound around said axis, wherein said winding has first turns arranged in a first plane, second turns arranged in a second plane, and third turns arranged in a third plane, wherein wedge formed areas are formed in the inner periphery and the outer periphery between each adjacent plane of turns, and
members of insulating material arranged to cover some of the wedge formed areas,
wherein the members of insulating material cover a wedge formed area in the inner periphery and a wedge formed area in the outer periphery alternatingly, one insulating member covering the wedge formed area in the outer periphery between the first and the second plane, and another insulating member covering the wedge formed area in the inner periphery between the second and third plane.

2. The electrical machine according to claim 1, wherein said members of insulating material are arranged in contact with turns in adjacent planes.

3. The electrical machine according to claim 1, wherein said members of insulating material is arranged to cover a plurality of said wedge formed areas.

4. The electrical machine according claim 1, wherein said members of insulating material is one or more layers of insulating paper.

5. The electrical machine according to claim 4, wherein said members of insulating material are a thin barrier of Nomex.

6. The electrical machine according to claim 1, wherein said members of insulating material is a thin barrier of presspan.

7. The electrical machine according to claim 1, wherein said electrical machine is a reactor.

8. The electrical machine according to claim 1, wherein said electrical machine is a power transformer.

9. The electrical machine according to claim 8, wherein said power transformer is chilled by a liquid, and wherein said wedge formed areas are in contact with the liquid.

10. The electrical machine according to claim 9, wherein said liquid is oil.

11. The electrical machine according to claim 9, wherein said liquid is ester fluid.

12. The electrical machine according to claim 8, wherein said power transformer is a 3-phase power transformer.
